(19) United States
(12) Patent Application Publication
(10) Pub. No.: US 2021/0107256 A1
(43) Pub. Date: Apr. 15, 2021

(54) METHOD OF PRODUCING A COATED VEHICLE WINDSHIELD FOR A HEAD-UP DISPLAY (HUD)

(71) Applicant: SAINT-GOBAIN GLASS FRANCE, COURBEVOIE (FR)

(72) Inventors: Martin ARNDT, Aachen (DE); Malte LINN, Aachen (DE)

(21) Appl. No.: 16/613,679

(22) PCT Filed: Sep. 4, 2018
(86) PCT No.: PCT/EP2018/073646

§ 371 Date: Nov. 14, 2019

(30) Foreign Application Priority Data
Sep. 22, 2017 (EP) 17192514.2

(51) Int. Cl. B32B 17/10

(52) U.S. Cl. CPC B32B 17/10036; G02B 27/01; B32B 17/10761

(57) ABSTRACT

A method for determining pane thicknesses and a wedge angle of a coated windshield for a projection arrangement of a head-up display. A wedge angle and a combination of glass thicknesses are determined by means of which the glass ghost image and the layer ghost image are optimally reduced. The method proceeds from a starting thickness of the two glass panes of the windshield for which that wedge angle is determined, in an iterative process, that represents an optimal compromise between the minimization of the glass ghost image and the minimization of the layer ghost image. Then, the glass thicknesses are determined varied within a specified range for each combination of the optimal wedge angles. Thus, it is possible, iteratively, to identify that combination of glass thicknesses that results in the least occurrence of ghost images, in addition to the associated optimal wedge angle.

The invention relates to a method for determining pane thicknesses and a wedge angle of a coated vehicle windshield for a head-up display (HUD) as well as the production and use of such a vehicle windshield based thereon.

Modern automobiles are increasingly equipped with so-called head-up displays (HUDs). With a projector, for example, in the region of the dashboard or in the roof region, images are projected onto the windshield, reflected there, and perceived by the driver as a virtual image behind the windshield (from his point of view). Thus, important data can be projected into the drivers field of vision, for example, the current driving speed, navigation or warning messages, which the driver can perceive without having to divert his glance from the road. Head-up displays can thus contribute significantly to an increase in traffic safety.

With the head-up displays described above, the problem arises that the projector image is reflected on both surfaces of the windshield. Thus, the driver perceives not only the desired primary image but also a slightly offset secondary image, usually having less intensity. The latter is commonly referred to as a ghost image. As is known, this problem is solved in that the reflecting surfaces are arranged at an angle relative to one another deliberately selected such that the primary image and the ghost image coincide, as a result of which the ghost image is no longer distractingly noticeable. In prior art compound glazings for head-up displays, the angle is typically approx 0.5 mrad.

Windshields are made of two glass panes that are laminated to one another via a thermoplastic film. When the surfaces of the glass panes are to be arranged, as described, at an angle, it is common to use a thermoplastic film with non-constant thickness. This is also referred to as a “wedge-shaped film” or a “wedge film”. The angle between the two surfaces of the film is referred to as a “wedge angle”. Composite glasses for head-up displays with wedge films are known, for example, from EP1800855B1 or EP1880243A2.

The displacement of the ghost image relative to the primary image, and thus its conspicuousness, depends essentially on the distance between the two reflection surfaces. The ghost image can, consequently, also be reduced by reducing the layer thicknesses of the components of the windshield.

It is also known to provide windshields with transparent, electrically conductive coatings. These coatings can act as IR reflecting coatings to reduce the heating up of the vehicle interior and thus improve thermal comfort. The coatings can, however, also be used as heatable coatings by connecting them to a voltage source such that a current flows through the coating. Suitable coatings include conductive, metallic layers based on silver. Since these coatings are susceptible to corrosion, it is customary to apply them on the surface of the outer pane or the inner pane facing the intermediate layer such that they have no contact with the atmosphere. Silver-containing transparent coatings are known, for example, from WO 03/024155, US 2007/0082219 A1, US 2007/0020465 A1, WO2013/104438, or WO2013/104439.

Windshields with conductive coatings in the interior of the composite glass have, in connection with head-up displays, the problem that an additional reflecting boundary surface for the projector image is formed by the conductive coating. This results in another undesirable secondary image, which is also referred to as a “layer ghost image” or a “layer ghost”.

DE102014005977 discloses an HUD projection arrangement with a coated windshield. To avoid the layer ghost, it is proposed to filter near IR radiation components out of the projector image in order to reduce the reflection on the coating. However, the solution has the disadvantage that the projector must be modified accordingly. Also, the entire visible spectrum is no longer available for the generation of the display image.

In principle, the layer ghost image can also be reduced by a wedge angle between the inner pane surface and the coating. However, avoiding the primary ghost image and the layer ghost image requires different wedge angles. Consequently, a compromise that results in an acceptable reduction of both ghost images must always be found.

The object of the invention is to provide a method with which a wedge angle and glass thicknesses of a windshield can be determined such that both ghost images are minimised.

The object of the present invention is accomplished according to the invention by a method in accordance with claim 1. Preferred embodiments are evident from the dependent claims.

The method according to the invention is used to determine optimal pane thicknesses and an optimal wedge angle of a coated windshield for a projection arrangement of a head-up display (HUD). Herein, a wedge angle and a combination of glass thicknesses, with which both ghost images are optimally reduced, are determined using a multiply iterative method. The method proceeds from a starting thickness of the two glass panes of the windshield, for which, in an iterative process, that wedge angle is deter him and mined that constitutes an optimal compromise between the minimization of the glass ghost image and the minimization of the layer ghost image. Then, the glass thicknesses are varied within a specified range and the optimal wedge angle is, in turn, determined for each combination. Thus, iteratively, that combination of glass thicknesses can be found, which results in the lowest occurrence of ghost images, in addition to the associated optimal wedge angle. Using the method according to the invention, windshields with which both ghost images are only minimally perceivable can be designed and produced.

The windshield comprises an outer pane and an inner pane that are joined to one another via a thermoplastic intermediate layer. The windshield is intended, in a window opening of a motor vehicle, to separate the interior from the outside environment. In the context of the invention, the term “inner pane” refers to the pane of the composite pane facing the interior (vehicle interior). The term “outer pane” refers to the pane facing the outside environment.

The windshield has an upper edge and a lower edge. “Upper edge” refers to that edge that is intended to point upward in the installed position. “Lower edge” refers to that edge that is intended to point downward in the installed position. The upper edge is also often referred to as the “roof edge”; and the lower edge, as “engine edge”. The windshield is preferably a motor vehicle windshield, in particular the windshield of a passenger car.

The projection arrangement for the HUD comprises at least the windshield and a projector. As usual with HUDs, the projector irradiates a region of the windshield where the radiation is reflected in the direction of the viewer (driver), creating a virtual image that the viewer perceives as behind the windshield from his point of view. The region of the windshield that can be irradiated by the projector is referred to as the “HUD region”. The projector is aimed toward the HUD region.

The thickness of the intermediate layer is variable in the vertical course between the lower edge and the upper edge of the windshield at least in the HUD region, increases in particular in the vertical course between the lower edge and the upper edge of the windshield. In other words, the intermediate layer has, at least in the HUD region, a finite wedge angle, i.e., a wedge angle greater than 0° such that the thickness of the intermediate layer changes depending on location. “Wedge angle” refers to the angle between the two surfaces of the intermediate layer. The intermediate layer is, at least in the HUD region, implemented wedge-shaped or as a wedge film. However, the thickness can also vary in the entire vertical course, for example, can increase monotonically from the lower edge to the upper edge. The term “vertical course” refers to the course between the upper edge and the lower edge with the direction of the course being substantially perpendicular to said edges. Since, in windshields, the upper edge can deviate greatly from a straight line, the vertical course is more precisely aligned perpendicular to the connecting line between the corners of the upper edge. The wedge angle is usually from 0.05 mrad to 2 mrad. With this, in typical head-up displays, good results are obtained in terms of ghost image prevention.

The desired virtual image is generated by reflection of the projector radiation on the interior-side surface of the inner pane facing away from the intermediate layer. The part of the beam not reflected passes through the composite pane and is reflected once again on the exterior-side surface of the outer pane facing away from the intermediate layer. Thus, an undesirable second virtual image, the so-called “ghost image” or “glass ghost” is generated. In the case of parallel pane surfaces, the image and the ghost image would appear offset relative to one another, which is bothersome for the viewer. By means of the wedge angle, the ghost image substantially coincides spatially with the image such that the viewer still perceives only a single image.

The direction of irradiation of the projector can typically be varied by mirrors, in particular vertically, in order to adapt the projection to the body size of the viewer. The region in which the eyes of the viewer must be situated with a given mirror position is referred to as the “eye box window”. This eye box window can be shifted vertically by adjustment of the mirrors, with the entire area thus available (i.e., the overlay of all possible eye box windows) referred to as the “eye box”. An viewer situated within the eye box can perceive the virtual image. This, of course, means that the eyes of the viewer must be situated within the eye box not, for example, the entire body.

The technical terms from the field of HUDs used here are generally known to the person skilled in the art. For a detailed presentation, reference is made to the dissertation “Simulation-Based Metrology for Testing Head-Up Displays” by Alexander Neumann at the Informatics Institute of Munich Technical University (Munich: University Library of Munich TU, 2012), in particular to chapter 2 “The Head-Up Display”.

The windshield has a transparent, electrically conductive coating that is applied on the interior-side surface of the outer pane facing the intermediate layer. By means of the coating, another boundary surface with a significant change in the refractive index is produced, i.e., another reflecting boundary surface for the light beam of the HUD projector. The coating thus generates another undesirable ghost image, the so-called “layer ghost image” or “layer ghost”. It is essential for the method according to the invention that the intermediate layer is arranged not only between the two reflection planes of the glass ghost image (interior-side surface of the inner pane, exterior-side surface of the outer pane), but also between the two reflection planes of the layer ghost image (interior-side surface of the inner pane, conductive coating). According to the invention, the conductive coating is, consequently, applied on the interior-side surface of the outer pane, not, for instance, on the exterior-side surface of the inner pane.

First, a starting thickness (d_{A}⁰) of the outer pane and a starting thickness (d_{I}⁰) of the inner pane are selected. The starting thicknesses are preferably thicknesses, as are customary for prior art windshields and as are potentially desired by the vehicle manufacturer. The starting thicknesses of the outer pane and of the inner pane are preferably selected from the range of 1.2 mm to 3 mm, particularly preferably 1.4 mm to 2.6 mm.

Using the starting thicknesses selected, a wedge angle is determined, which is referred to in the context of the invention as a glass wedge angle (α_{G}) and which results in the fact that the glass ghost image disappears at a reference point within the HUD region, i.e., ideally coincides with the primary image. The geometric centre of the HUD region is preferably selected as the reference point. The calculation is based on a standard eye position that is typically specified to the glass manufacturer by the automobile manufacturer. The disappearance of the ghost image is perfect only at the reference point and only for the standard eye position. At other points within the HUD region and for other eye positions, a more or less pronounced ghost image still appears.

Similarly, a wedge angle is determined for the starting thicknesses, which is referred to in the context of the invention as a layer wedge angle (α_{C}) and which results in the fact that the layer ghost image disappears at the reference point within the HUD region, i.e., ideally coincides with the primary image.

Now, the wedge angle that represents the optimal compromise between the layer wedge angle and the glass wedge angle is sought. In the context of the invention, it is referred to as mean wedge angle (αₒₚₜ) and is numerically between the layer wedge angle and the glass wedge angle. The term “mean wedge angle” does not mean that a simple mathematical averaging is performed. Instead, the mean wedge angle represents the optimal compromise between the glass wedge angle and the layer wedge angle, which results overall in the maximum reduction of the ghost images.

During optimization, i.e., during the search for the mean wedge angle (αₒₚₜ), the maximally occurring glass ghost image (G_{G}) Is now determined for each possible wedge angle. This means the most pronounced ghost image that can occur with the use of the respective wedge angle, and, at the most unfavourable location within the HUD field and with the most unfavourable eye position within the eye box. The most pronounced ghost image is the ghost image having the quantitatively greatest distance from the primary image. A ghost image can, for example, be quantitatively expressed as the distance between the primary image and the ghost image in the image plane, or as the angle that the beams of the primary image and of the ghost image together enclose. The position of the eyes of the viewer is referred to as “eye position”. It is, in particular, a function of the body size and the seat position of the viewer. Likewise, the maximally occurring layer ghost image (G_{C}) Is determined analogously using the respective wedge angle.

The mean wedge angle is determined in an iterative process as the wedge angle, with which a minimal quantitative difference between the glass ghost image and the layer ghost image occurs. In this case, the ghost images are as similar as possible, which decreases their perceivability. Common iteration methods known per se to the person skilled in the art are suitable, for example, the Newtonian iteration process.

Instead of considering only the absolute difference (distance or angle) between the ghost images, in a further development of the invention, the intensity of the ghost images can also be considered as a weighting factor for the difference. The mean wedge angle is then determined iteratively as that wedge angle with which a minimally weighted difference between the glass ghost image and the layer ghost image occurs. The weighted difference is the absolute difference weighted with the intensity of the layer ghost image and the intensity of the glass ghost image, where low intensities result in lower weighting and high intensities in higher weighting. Thus, it is possible to determine a mean wedge angle at which the quantitative difference of the ghost images is not minimal, but the ghost images are less distracting due to their low intensity.

Of course, the individual steps do not do not have to be carried out strictly in the order indicated here. What is important is the determination of the glass wedge angle and of the layer wedge angle and the subsequent iteration process for determining the mean wedge angle with the minimal difference in the ghost images, wherein the necessary steps can be carried out in any order.

After the mean wedge angle was determined for the starting thicknesses of the panes, the method according to the invention now attempts to find a new combination of glass thicknesses with which the difference between the maximum ghost images can be further reduced. It must be taken into account that the glass thicknesses cannot be arbitrarily changed since the windshield must fulfill certain requirements for stability, noise damping, stone impact resistance, or other specifications of the vehicle manufacturer. Consequently, ranges of permissible values for the thicknesses of the two panes, within which acceptable glass thicknesses occur, must first be defined. The thickness of the outer pane can then be varied within the range of permissible values (Δd_{A}) for the outer pane, and the thickness of the inner panes, within the range of permissible values (Δd_{I}) for the inner pane.

Since not every glass thickness is available to the glass manufacturer, but typically only discrete glass thicknesses, for example, in steps of 0.1 mm, the ranges of permissible values for the thicknesses must, of course, not be construed as a continuous interval, but as a collection of discrete thickness values that are available to the glass manufacturer. The ranges of permissible values can, consequently, also be characterised as sets of permissible values, which is basically more accurate.

Again, the combination of pane thicknesses, with whose mean wedge angle the lowest quantitative difference between the glass ghost image and the layer ghost image occurs, is sought iteratively. For this purpose, the thickness of the outer pane (d_{A}) and/or the thickness of the inner pane (d_{I}) is changed relative to the starting thickness and the mean wedge angle is determined for the new combination of glass thicknesses, as described above in connection with the starting thicknesses (calculation of α_{G} and of α_{C}, iterative determination of αₒₚₜ between α_{G} and α_{C}).

The pane thicknesses are now changed repeatedly, until all possible combinations of thicknesses of the outer pane and the inner pane within the ranges of permissible values are covered and their associated mean wedge angle is determined.

It is not necessary under all circumstances to work through previously defined ranges of permissible values completely. It is, in principle, also conceivable to terminate the process when the value for the difference of the ghost images drops below a specified limit value for an investigated combination of pane thicknesses. To simplify the description, in this case, the pane thickness values already considered can be regarded as ranges of permissible values in the context of the invention.

Since the extent of the ghost images depends essentially on the distance between the reflection surfaces, the method according to the invention will typically result in glass thicknesses that are lower than the initial thicknesses. This is true in particular for the inner pane, since a low thickness of the inner pane reduces the distances both between the reflection surfaces of the glass ghost image and also between the reflection surfaces of the layer ghost image. Consequently, it is particularly advantageous to reduce the thickness of the inner pane as much as possible. A reduction in the thickness of the outer pane also certainly has a positive effect on the reduction of the glass ghost image; however, for reasons of stability, breaking strength, or noise damping, it can be necessary to reduce the thickness of the outer pane less than the thickness of the inner pane, or even to increase the thickness of the outer pane compared to the starting thickness. In a preferred embodiment, the starting thickness of the inner pane is, consequently, the upper limit of the range of permissible values for the thickness of the inner pane such that, in the method, only those thicknesses of the inner pane that are lower than the starting thickness are considered. In a particularly preferred embodiment, the starting thickness of the outer pane is also the upper limit of the range of permissible values for the thickness of the outer pane.

Finally, that combination of glass thicknesses for whose associated mean wedge angle the smallest quantitative difference between the glass ghost image and the layer ghost image was determined is selected from the results of the calculation. Here, as well, in a further improvement of the invention, it is conceivable to weight the absolute difference with the intensity of the ghost images. Then, the combination of glass thicknesses for whose associated mean wedge angle the smallest weighted difference between the glass ghost image and the layer ghost image was determined is selected. The thickness of the outer pane of this combination is referred to in the context of the invention as the final thickness (d_{A}^{f}) of the outer pane; the thickness of the inner pane, as the final thickness (d_{I}^{f}) of the inner pane; and the mean wedge angle, as the mean final wedge angle (αₒₚₜ^{f}). The final thicknesses and the associated mean final wedge angle constitute the final result of the method and characterise the windshield with which the best results are achieved in terms of avoiding ghost images.

The starting thickness of the inner pane is preferably less than or equal to the starting thickness of the outer pane. The final thickness of the inner pane is preferably less than the final thickness of the outer pane.

For the calculation of the wedge angles and the ghost images, not only the pane thicknesses are decisive, but also other parameters that define the windshield and the projection arrangement which are, however, in contrast to the pane thicknesses and the wedge angle fixed with no room for changes. Thus, the distance between the reflection surfaces is also determined by the thickness of the thermoplastic intermediate layer in addition to the pane thicknesses.

In addition to the pane thicknesses, the thickness of the thermoplastic intermediate layer can also be used as a variation parameter. In this case, at the beginning, a starting thickness of the intermediate layer that is associated with the starting thicknesses of the inner pane and the outer pane is defined. For the starting thicknesses, the mean wedge angle is determined as described. A range of permissible values is also defined for the thickness of the intermediate layer, within which the thickness of the intermediate layer is varied during the iteration process. The mean wedge angle is determined for each possible combination of thicknesses of the outer pane, the inner pane, and the intermediate layer. The mean wedge angle with the smallest quantitative difference between the glass ghost image and the layer ghost image yields a combination of final thicknesses of the outer pane, of the inner pane, and of the intermediate layer as a result of the process. The glass manufacturer is, however, less free in the selection of the thickness of the intermediate layer than in the selection of the glass pane thicknesses because the permissible values are usually strongly limited downward and a significant increase in the thickness usually does not lead to satisfactory results in terms of the ghost images. Consequently, in order to simplify the process, variation in the thickness of the intermediate layer is preferably rejected.

In addition, the windshield is typically curved three-dimensionally (i.e., in both spatial directions), as is customary in motor vehicles. The curvature of the windshield can be characterised by a distribution of local radii of curvature, which are, for example, indicated as a function of the relative positional coordinates of the windshield. Here, a distinction must also be made between the vertical radius of curvature (curvature in the vertical dimension) and the horizontal radius of curvature (curvature in the horizontal dimension). Large radii of curvature correspond to a low curvature; small radii of curvature, to a high curvature of the pane. Typical radii of curvature windshields are in the range from 1 m to 40 m, in particular from 2 m to 15 m.

The position of the projector relative to the HUD region as well as the installation angle of the windshield must also be taken into account. The installation angle is the angle that the windshield encloses with the vertical in the installed position, wherein, for the exact determination, the tangent at the centre of the pane can be used. For passenger cars, the installation angle is typically from 50° to 70°, in particular approx. 60°.

The position of the projector, the installation angle, and the curvature profile of the pane essentially determine the local angle of incidence of the projector radiation on the HUD region.

The methods for calculating wedge angles and ghost images are known to the person skilled in the art. Thus, EP 0 420 228 A2 describes in detail the numerical calculation of wedge angles and ghost images using a set of formulae (Formulae (4) to (12) on page 5), which is, by reference, part of the present application. However, the set of formulae must be understood only as an exemplary embodiment. There may also be other possible sets of formulae for calculating wedge angles and ghost images that can also be used for the method according to the invention.

Proceeding from the determination according to the invention of the values for the pane thicknesses and the wedge angle, the invention also includes a method for producing a coated windshield for a projection arrangement of a head-up display (HUD). First, an outer pane with the determined final thickness (d_{A}^{f}) of the outer pane is provided as well as an inner pane with the determined final thickness (d_{I}^{f}) of the inner pane. Then, a transparent, electrically conductive coating is applied on a surface of the outer pane. Next, a thermoplastic intermediate layer having the mean final wedge angle (αₒₚₜ^{f}) is arranged between the outer pane and the inner pane, with the transparent, electrically conductive coating facing the intermediate layer. The layer stack thus obtained comprising the inner pane, the intermediate layer, and the outer layer, arranged sheet-wise one over another, is then laminated to form the windshield.

The outer pane and the inner pane preferably contain glass, in particular soda lime glass. The panes can, however, in principle, also contain other types of glass, such as quartz glass or borosilicate glass, or even rigid clear plastics, in particular polycarbonate (PC) or polymethyl methacrylate (PMMA).

The outer pane and the inner pane are typically provided as flat panes and then subjected to a bending process to produce the desired the curvature profile. In principle, for this, all known bending methods are suitable, for example, gravity bending, press bending, and/or suction bending. Preferably, the outer pane and the inner pane are bent congruently together (i.e., at the same time and by the same tool), since, thus, the shape of the panes is optimally matched for the subsequently occurring lamination. Typical temperatures for glass bending processes are, for example, 500° C. to 700° C.

The transparent, electrically conductive coating can be a single layer, but is typically a multilayer system. The term “transparent coating” means a coating with transmittance in the visible spectral range of at least 70%, preferably at least 90%. The coating includes at least one electrically conductive layer. Typically, the coating includes additional, dielectric layers, which, as antireflection layers, blocking layers, or surface matching layers, optimise the optical, electrical, and/or mechanical properties of the coating. The at least one electrically conductive layer can contain a metal, a metal alloy, or a transparent conductive oxide (TCO), for example, indium tin oxide (ITO). In a preferred embodiment, the at least one electrically conductive layer contains silver. The silver content of the layer is preferably greater than 50%, particularly preferably greater than 90%. The layer is most particularly preferably substantially made of silver, apart from any impurities or dopants. The conductive coating can preferably contain a plurality of electrically conductive layers that are separated from one another by dielectric layers. Through the splitting of the conductive materials into a plurality of thin layers, high electrical conductivity can be achieved along with high optical transmittance. The coating preferably contains at least two, particularly preferably two or three, conductive layers, in particular silver-containing layers. Typical materials that are commonly used for the dielectric layers of the conductive coating are, for example, silicon nitride, silicon oxide, zinc oxide, tin zinc oxide, and aluminum nitride. The coating is typically a thin-film stack. Typical thicknesses of the coating are less than 1 μm. Typical thicknesses of the conductive layers are in the range from 5 nm to 50 nm for silver-containing layers and 50 nm to 500 nm for TCO-containing layers.

The coating is preferably applied on the entire surface of the outer pane, typically, minus a circumferential edge region with a width of up to 10 cm and any locally limited, coating-free regions that serve, for example, as data transmission or sensor windows. The coating preferably covers at least 80%, particularly preferably at least 90% of the pane surface. The HUD region is preferably completely provided with the coating.

The electrically conductive coating according to the invention can be an IR reflecting coating and serve as a solar protection coating to prevent the heating up of the interior delimited by the composite pane by the IR component of sunlight. The coating can also be heatable. To that end, the coating is connected to a voltage source, typically via so-called bus bars, such that a current flows across the coating which heats up as a result, providing the heating function.

The application of the coating can, in principle, be done before or after the bending of the outer pane. Technically, it is usually simpler to coat the flat pane and then to bend it. The individual layers of the coating are deposited by methods known per se, preferably by magnetron-enhanced cathodic sputtering, which has proved itself particularly for generating optically high-value thin films. The cathodic sputtering is done in a protective gas atmosphere, for example, of argon, or in a reactive gas atmosphere, for example, by addition of oxygen or nitrogen. The layers can, however, also be applied using other methods known to the person skilled in the art, for example, by vapour deposition or chemical vapour deposition (CVD), by atomic layer deposition (ALD), by plasma-enhanced chemical vapour deposition (PECVD), or using wet chemical methods.

The thermoplastic intermediate layer is provided as a film, in particular as a so-called “wedge film”, meaning a thermoplastic laminating film having increasing thickness, at least in sections. The wedge angle can be introduced into the film by stretching a film with (in its initial state) substantially constant thickness or by extrusion using a wedge-shaped extrusion die. The intermediate layer can be implemented by a single film or even by more than one film. In the latter case, at least one of the films must be designed with the wedge angle. The intermediate layer can also be implemented as a so-called “acoustic film” that has a noise-damping effect, or contain such a film. Such films typically consists of at least three plies, wherein the middle ply has higher plasticity or elasticity than the surrounding outer layers, for example, as a result of a higher plasticiser content.

The thermoplastic intermediate layer contains at least a thermoplastic polymer, preferably ethylene vinyl acetate (EVA), polyvinyl butyral (PVB), or polyurethane (PU) or mixtures or copolymers or derivatives thereof, particularly preferably PVB. The minimum thickness of the thermoplastic bonding film is preferably from 0.2 mm to 2 mm, particularly preferably from 0.3 mm to 1 mm. “Minimum thickness” refers to the thickness at the thinnest point of the intermediate layer.

The production of the windshield is done by lamination with customary methods known per se to the person skilled in the art, for example, autoclave methods, vacuum bag methods, vacuum ring methods, calender methods, vacuum laminators, or combinations thereof. The bonding of the outer pane and the inner pane is customarily done under the action of heat, vacuum, and/or pressure.

The outer pane, the inner pane, and/or the thermoplastic intermediate layer can be clear and colourless, but also tinted or coloured. In a preferred embodiment, the total transmittance through the windshield is greater than 70%. The term “total transmittance” is based on the process for testing the light permeability of motor vehicle windows specified by ECE-R 43, Annex 3, § 9.1.

The invention includes, moreover, the use of a windshield produced by the method according to the invention in a vehicle, preferably in a motor vehicle, in particular in a passenger car as part of a projection arrangement for a head-up display (HUD). The windshield and the projector are arranged relative to one another typically by installation in the vehicle body, creating the projection arrangement.

In the following, the invention is explained in detail with reference to drawings and exemplary embodiments. The drawings are schematic representations and are not to scale. The drawings in no way restrict the invention.

They depict:

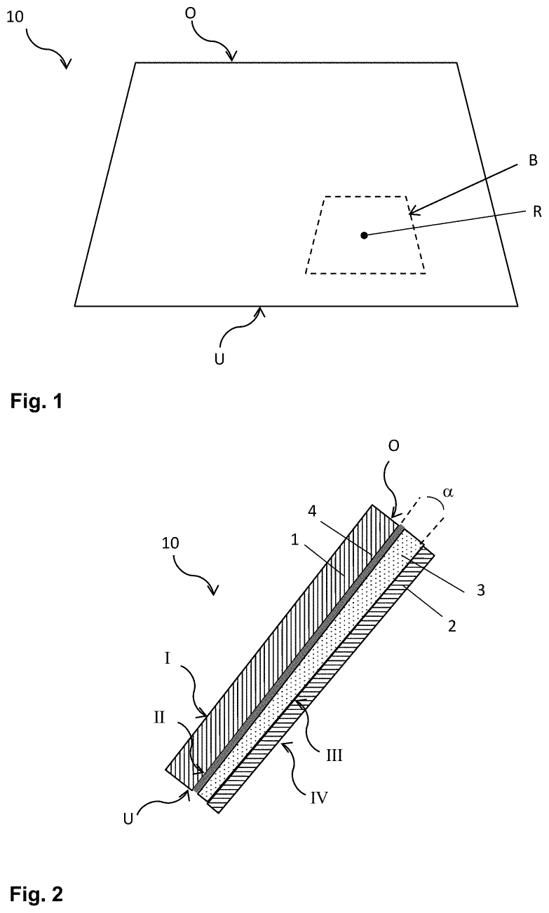

FIG. 1 a plan view of a generic windshield,

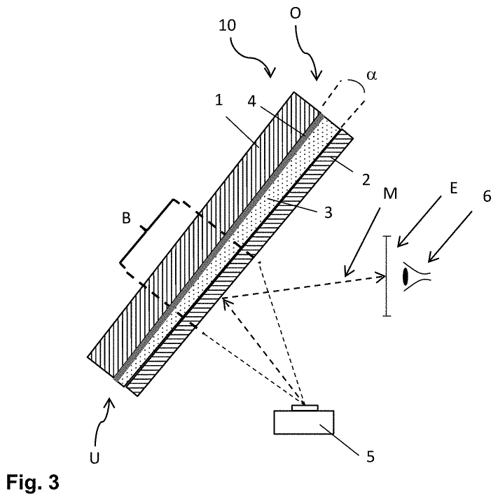

FIG. 2 a cross-section through the windshield of FIG. 1,

FIG. 3 a cross-section through a generic projection arrangement,

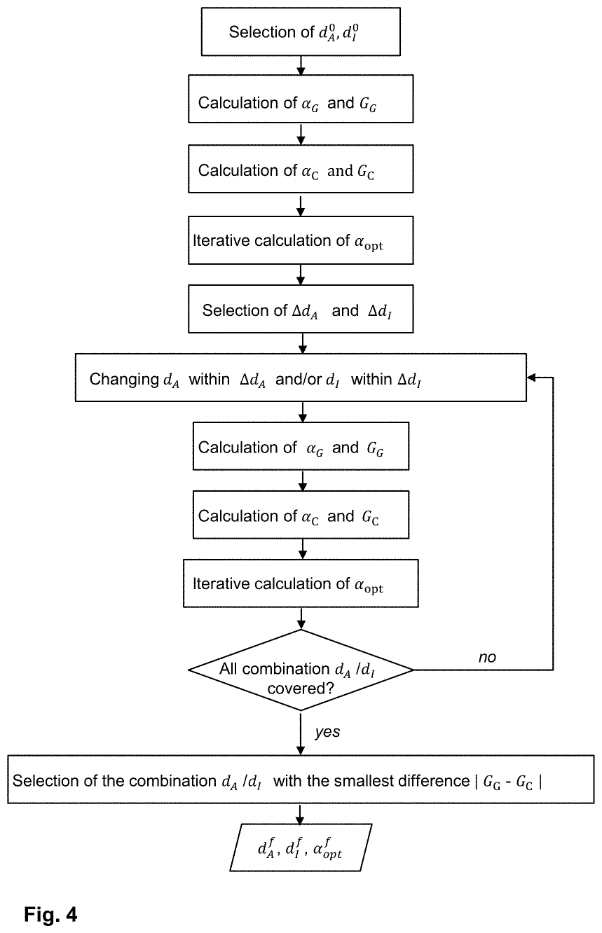

FIG. 4 a flowchart of an embodiment of the method according to the invention for determining pane thicknesses and a suitable wedge angle, and

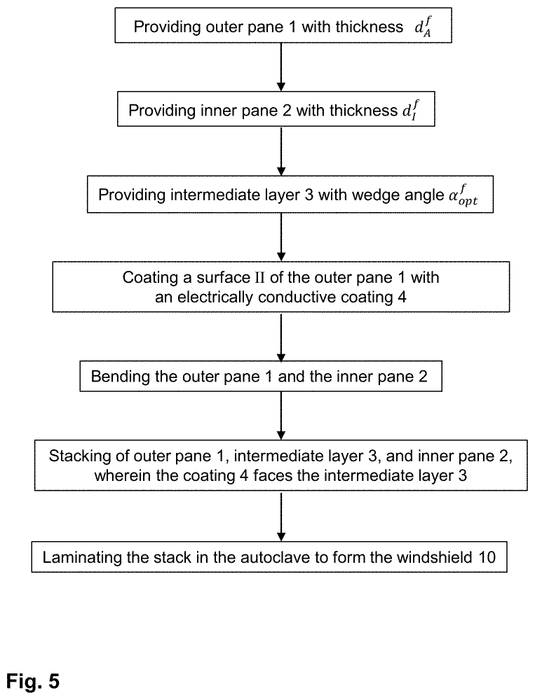

FIG. 5 a flowchart of an embodiment of the method according to the invention for producing a windshield.

FIG. 1 and FIG. 2 depict in each case a detail of a composite pane 10 according to the invention, which comprises an outer pane 1 and an inner pane 2 that are joined to one another via a thermoplastic intermediate layer 3. The composite pane 10 is intended als a windshield of a motor vehicle that is equipped with a head-up display. In the installed position, the outer pane 1 faces the outside environment; the inner pane 2, vehicle interior. In the installed position, the upper edge O of the composite pane 10 points upward toward the vehicle roof (roof edge); the lower edge U, downward toward the engine compartment (engine edge).

The outer pane 1 has an exterior-side surface I that faces the outside environment in the installed position and an interior-side surface II that faces the interior in the installed position. Likewise, the inner pane 2 has an exterior-side surface III that faces the outside environment in the installed position and an interior-side surface IV that faces the interior in the installed position. The interior-side surface II of the outer pane 1 is joined to the exterior-side surface III of the inner pane 2 via the intermediate layer 3.

A region B, corresponding to the HUD region of the composite pane 10, is also indicated In the figure. In this region, images are to be produced by an HUD projector. The primary reflection on the interior-side surface IV of the inner pane 2 produces the desired HUD display as a virtual image. The non-reflected radiation components penetrate through the composite pane 10 and are reflected again on the exterior-side surface I of the outer pane 1 (secondary reflection). The secondary reflection creates the glass ghost image G_{G} that is offset relative to the primary image. The centre of the HUD region B serves as reference point R for calculating wedge angles.

The thickness of the intermediate layer 3 increases steadily in the vertical course from the lower edge U to the upper edge O. For the sake of simplicity, the increase in thickness is shown as linear; however, it can also have more complex profiles. The intermediate layer 3 is formed from a single film of PVB (a so-called “wedge film” with variable thickness). The extent of the change in thickness is delineated thereby.

The composite pane 10 also has an electrically conductive coating 4 on the interior-side surface II of the outer pane 1. The coating 4 is IR reflecting and is intended to reduce the heating of the vehicle interior by the IR component of sunlight. The coating 4 is, for example, a thin-film stack containing two or three layers of silver and other dielectric layers.

The coating 4 constitutes a further reflecting boundary surface in the interior of the composite pane 10, on which the projector image is again reflected and thus results in an undesirable secondary image, the so-called layer ghost image G_{C}.

Due to the wedge-shaped implementation of the intermediate layer 3, in principle, ghost images can be avoided or at least reduced, in that the primary image and the ghost image coincide. The secondary reflection then no longer appears offset relative to the primary reflection. In the present case, there is, however, the problem, that avoiding the glass ghost image and avoiding the layer ghost image make different demands on the wedge angle oc. In the context of a compromise, a wedge angle α must be found that satisfactorily reduces both ghost images.

The outer pane 1 and the inner pane 2 are made, for example, of soda lime glass. The intermediate layer 3 is formed here by a single, wedge-shaped PVB film. The minimum thickness of the intermediate layer 3 is, for example, 0.76 mm (measured at the lower edge U). However, a multilayer structure of the intermediate layer 3 is also conceivable, for example, a 0.36-mm-thick PVB film with a constant thickness, a 0.76-mm-thick PVB wedge film, and a 0.05-mm-thick PET film positioned therebetween.

For the sake of simplicity, the windshield is shown planar, but has, in reality, a three-dimensional curvature that must be taken into account in the determination of the wedge angles and ghost images.

FIG. 3 depicts the composite pane 10 of FIGS. 1 and 2 as part of a projection arrangement for an HUD. The arrangement comprises, in addition to the composite pane 10, a projector 5, which is aimed toward the HUD region B. The projector 5 can generate images in the HUD region B that are perceived by the viewer 6 (vehicle driver) as virtual images on the side of the composite pane 10 facing away from him.

The region within which the eyes of the viewer 6 must be situated in order to perceive the virtual image is referred to as the “eye box window”. The eye box window is vertically displaceable by mirrors in the projector 5, in order to adapt the HUD to viewers 6 of different body size and seat position. The entire accessible region within which the eye box window can be displaced is referred to as “eye box E”. The beam that connects the projector 5 with the centre of the eye box E (usually the mirrors of the projector 5 are in the zero position) is referred to as centre beam M. The point on the inner pane 2, where the centre beam M strikes, is a characteristic parameter in the design of HUD projection arrangements.

FIG. 4 depicts a flowchart of an exemplary embodiment of the method according to the invention for determining pane thicknesses and a wedge angle. First, the starting thicknesses d_{A}⁰, d_{I}⁰ of the outer pane 1 and of the inner pane 2 are selected. These values are used to calculate the glass wedge angle α_{G} and the glass ghost image G_{G} maximally occurring therewith and the layer wedge angle α_{C} and the layer ghost image G_{C} maximally occurring therewith. Then, the mean wedge angle αₒₚₜ, that is numerically between the glass wedge angle α_{G} and the layer wedge angle α_{C} and results in a minimal quantitative difference between the maximally occurring glass ghost image G_{G} and the maximally occurring layer ghost image G_{C} is determined iteratively. The calculation of the maximally occurring ghost images with the original glass wedge angle and the original layer wedge angle is not essential, but later enables estimating the extent to which the occurrence of ghost images has been improved by the optimization method according to the invention.

Then, ranges Δd_{A}, Δd_{I} of permissible values for the pane thicknesses d_{A}, d_{I} are selected, which, of course, also can be done and, in practice, is done already at the beginning of the process after the selection of the starting thicknesses d_{A}⁰, d_{I}⁰. The pane thicknesses d_{A}, d_{I} within the ranges Δd_{A}, Δd_{I} are repeatedly changed and determined for each possible combination of pane thicknesses d_{A}, d_{I} of the mean wedge angle αₒₚₜ. When all possible combinations of the pane thicknesses d_{A}, d_{I} have been considered, the combination whose associated mean wedge angle αₒₚₜ yields the smallest difference between glass ghost image G_{G} and layer ghost image G_{C} Is selected. The pane thicknesses and this mean wedge angle constitute, as final thicknesses d_{A}^{f}, d_{I}^{f} and as mean final wedge angle αₒₚₜ the results of the process.

### EXAMPLE

The following starting thicknesses, which correspond to a standard windshield with a total thickness of 4.46 mm, were selected:
starting thickness d_{A}³=2.1 mm
starting thickness d_{I}⁰=1.6 mm
thickness of the intermediate layer 3=0.76 mm

The following wedge angle and ghost images were calculated therewith:
glass wedge angle α_{G}=0.52 mrad
maximally occurring glass ghost image G_{G}=1.21 mm
layer wedge angle α_{C}=0.24 mrad
maximally occurring layer ghost image G_{C}=2.95 mm

Then, a mean wedge angle αₒₚₜ of 0.38 mrad, for which the difference between G_{G} and G_{C} mit 0.03 mm was minimal (G_{G}=1.70 mm; G_{C}=1.73 mm) was determined iteratively.

The following ranges of permissible values for the pane thicknesses were defined (values in the unit mm, in each case):
Δd_{A}={2.6; 2.1; 1.8; 1.6; 1.4}
Δd_{I}={2.1; 1.8; 1.6; 1.4; 1.2; 1.0; 0.9; 0.7; 0.5}

The pane thicknesses were then varied, and for each possible combination of d_{A} and d_{I}, the associated mean wedge angle αₒₚₜ with the associated difference between G_{G} and G_{C} was determined. Then, that combination was selected that yielded the smallest difference between G_{G} and G_{C}. The result was as follows:
final thickness d_{I}^{f}=0.7 mm

With the unchanged thickness of the intermediate layer 3 of 0.76 mm, a total thickness of the windshield 10 of 3.06 mm was obtained. For this combination, the following wedge angles were calculated:
glass wedge angle α_{G}=0.355 mrad
layer wedge angle α_{C}=0.162 mrad
mean final wedge angle αₒₚₜ^{f}=0.25 mm

With αₒₚₜ^{f}, a maximally occurring glass ghost image G_{G} of 1.18 mm and a maximally occurring layer ghost image G_{C} of 1.13 mm were obtained, corresponding to a difference of 0.05 mm, representing the minimally observed value.

FIG. 5 depicts in continuation of the method of FIG. 4, a flowchart of an exemplary embodiment of the method according to the invention for producing a coated windshield.

### LIST OF REFERENCE CHARACTERS

(10) windshield
(1) outer pane
(2) inner pane
(3) thermoplastic intermediate layer
(4) electrically conductive coating
(5) projector
(6) viewer/vehicle driver
(O) upper edge of the windshield 10
(U) lower edge of the windshield 10
(B) HUD region of the windshield 1
(I) exterior-side surface of the outer pane 1
(II) interior-side surface of the outer pane 1
(III) exterior-side surface of the inner pane 2
(IV) interior-side surface of the inner pane 2
(α) wedge angle of the intermediate layer 3
(E) eye box
(M) centre beam (between projector 5 and center of the eye box E)
(R) reference point for determining the wedge angle
(d_{A}) thickness of the outer pane 1
(d_{A}⁰) starting thickness of the outer pane 1
(d_{A}^{f}) final thickness of the outer pane 1
(d_{I}) thickness of the inner pane 2
(d_{I}⁰) starting thickness of the inner pane 2
(d_{I}^{f}) final thickness of the inner pane 2
(Δd_{A}) range of permissible values for d_{A}
(Δd_{I}) range of permissible values for d_{I}
(α_{G}) glass wedge angle
(α_{C}) layer wedge angle
(αₒₚₜ) mean wedge angle
(aₒₚₜ^{f}) mean final wedge angle
(G_{G}) maximally occurring glass ghost image
(G_{C}) maximally occurring layer ghost image

1. Method for determining pane thicknesses and a wedge angle of a coated windshield for a projection arrangement of a head-up display, wherein
the windshield comprises an outer pane and an inner pane, joined to one another via a thermoplastic intermediate layer, and has an upper edge, a lower edge, and an HUD region, wherein the thickness of the thermoplastic intermediate layer increases in the vertical course between the lower edge and the upper edge at least in the HUD region with a wedge angle,
a transparent, electrically conductive coating is applied on a surface of the outer pane facing the thermoplastic intermediate layer,
the projection arrangement comprises the windshield and a projector that is aimed toward the HUD region,
comprising:
(a) selecting a starting thickness of the outer pane and a starting thickness of the inner pane, and
(i) determining a glass wedge angle that results in disappearance of a glass ghost image at a reference point within the HUD region,
(ii) determining a layer wedge angle that results in disappearance of a layer ghost image at the reference point within the HUD region,
(iii) iteratively determining a mean wedge angle between the glass wedge angle and the layer wedge angle, for which a difference between a maximally occurring glass ghost image and a maximally occurring layer ghost image is minimal,
(b) changing the thickness of the outer pane within a range of permissible values and/or the thickness of the inner pane within a range of permissible values and determining a associated mean wedge angle using steps (i) through (iii),
(c) repeating step (b), until all possible combinations of thicknesses of the outer pane and inner pane within the ranges of permissible values are covered,
(d) selecting a final thickness of the outer pane and a final thickness of the inner pane, for whose associated mean final wedge angle the smallest difference between the glass ghost image and the layer ghost image was determined.

2. The method according to claim 1, wherein the starting thickness of the outer pane and the starting thickness of the inner pane are from 1.2 mm to 3 mm.

3. The method according to claim 1, wherein the reference point is arranged in a centre of the HUD region.

4. The method according to claim 1, wherein the starting thickness of the inner pane is an upper limit of the range of permissible values for the thickness of the inner pane.

5. The method according to claim 4, wherein the starting thickness of the outer pane is an upper limit of the range of permissible values for the thickness of the outer pane.

6. The method according to claim 1, wherein in steps (b) and (c), the thickness of the thermoplastic intermediate layer is also varied proceeding from a starting thickness within a range of permissible values until all possible combinations of thicknesses of the outer pane, inner pane, and thermoplastic intermediate layer within the ranges of permissible values are covered, wherein in step (d), in addition to the final thickness of the outer pane and the final thickness of the inner pane a final thickness of the thermoplastic intermediate layer is also selected, for whose associated mean final wedge angle the smallest difference between the glass ghost image and the layer ghost image was determined.

7. The method for producing a coated windshield for a projection arrangement of a head-up display, comprising:
(a) providing an outer pane and an inner pane having the final thicknesses determined according to claim 1,
(b) coating a surface of the outer pane with a transparent, electrically conductive coating,
(c) arranging a thermoplastic intermediate layer having the final wedge angle between the outer pane and the inner pane, wherein the electrically conductive coating faces the thermoplastic intermediate layer,
(d) laminating the outer pane to the inner pane via the thermoplastic intermediate layer to form the windshield.

8. The method according to claim 7, wherein the final wedge angle is introduced into the thermoplastic intermediate layer by stretching or by extrusion.

9. The method according to claim 7, wherein the outer pane and the inner pane are subjected to a bending process between the steps (b) and (c).

10. The method according to claim 7, wherein the transparent coating contains at least one silver layer.

11. The method according to claim 7, wherein the outer pane and the inner pane contain soda lime glass.

12. The method according to claim 7, wherein the thermoplastic intermediate layer contains at least polyvinyl butyral, ethylene vinyl acetate, polyurethane, or mixtures or copolymers or derivatives thereof, preferably PVB.

13. The method according to claim 7, wherein the thermoplastic intermediate layer is implemented as a noise-damping, multi-ply film.

14. A method comprising utilizing a windshield produced by the method according to claim 7 in a vehicle as part of a projection arrangement for a head-up display.

15. The method according to claim 14, wherein the vehicle is a motor vehicle.

16. The method according to claim 15, wherein the vehicle is a passenger car.
